(19) United States
(12) Patent Application Publication
(10) Pub. No.: US 2006/0061651 A1
(43) Pub. Date: Mar. 23, 2006

(54) THREE DIMENSIONAL IMAGE GENERATOR

(76) Inventor: Kenneth TETTERINGTON, Edmonton, Alberta (CA)

Correspondence Address: EDWARD YOO C/O BENNETT JONES, 1000 ATCO CENTRE, 10035 - 105 STREET, EDMONTON, ALBERTA, AB, T5J3T2, CA

(21) Appl. No.: 11/162,711

(22) Filed: Sep. 20, 2005

Related U.S. Application Data
(60) Provisional application No. 60/610,943, filed on Sep. 20, 2004.

(51) Int. Cl. H04N 13/04; H04N 13/00; H04N 15/00

(52) U.S. Cl. 348/51; 348/42

(57) ABSTRACT

A method and apparatus for producing a stereoscopic 3D image in a video game being displayed on a television or video monitor. The game player look-at position is shifted laterally to the left and right of the actual player look-at position during alternating vertical refresh cycles. A pair of liquid crystal glasses may be synchronized to the vertical refresh cycle such that a player wearing the glasses alternately sees the left-shifted image and the right-shifted image, producing a stereoscopic 3D image.

### CROSS REFERENCE TO RELATED APPLICATIONS

This application claims the priority benefit of U.S. Provisional Application No. 60/610,943 filed on Sep. 20, 2004 entitled “Three Dimensional Image Generator”, the contents of which are incorporated herein by reference.

### FIELD OF INVENTION

The present invention relates to a method and an apparatus for generating stereoscopic three-dimensional (3D) images using a conventional two-dimensional (2D) video game. In particular, the present invention relates to a 3D image display technique without the use of lenticular surfaces, pre-recorded stereoscopic 3D content, or conventional 2D-to-3D conversion techniques.

### BACKGROUND OF THE INVENTION

The presentation of fully 3D images has been a serious technological goal for the better part of the twentieth century. Initial methods for producing a 3D image of a scene employed a photographic plate exposed through a “fly's eye” lenticular sheet of small fixed lenses. This technique became known as “integral photography” and the display of the developed image was undertaken through the same sort of fixed lens lenticular sheet. However, such technology failed to produce a technology readily amenable to motion presentation, or capable of readily reproducing electronically generated images, the predominant format of more recent times.

There have been many extensions of the multiple-image-component approach to 3D imagery into a variety of technical developments that include various versions of ribbed lenticular or lattice sheets of optical elements for the production of stereo images from a single specially processed image. Most of these suffer from a common series of deficiencies, which include severe restrictions on the viewers physical position with respect to the viewer screen, reduced image quality resulting from splitting the produced image intensity between two separate images and in many, parallax viewable in only one direction. As well, the images may only be viewed against a solid and printed surface.

A variety of technologies relating to viewer-worn appliances has emerged, including eye glasses employing two-color or cross-polarized filters for the separation of concurrently displayed dual images, and virtual reality display headgear, all related to the production of stereopsis, that is, the perception of depth through the assimilation of separate left and right images.

Current stereoscopic techniques employed using a cathode ray tube such as used in modern color televisions utilize liquid crystal glasses (LCD) that alternate between clear and dark to allow only one eye to view the screen at a time. By alternately synchronizing the glasses clear state with a stereoscopic image pair, the television can display stereoscopic 3D to the viewer. Current technique relies on pre-rendered stereoscopic image pairs to be generated and displayed by a video signal, such as pre-recorded VHS tape, DVD or broadcast.

Current 2D-to-3D conversion processes utilize techniques to review and analyze a 2D image and employ algorithms to determine distance in the image by way of brightness, manual judgment or rotoscoping algorithms.

Current video game console systems such as the xBox™, Nintendo™ and Sony Playstation™ are immensely popular, but do not display stereoscopic video games unless the games are pre-programmed to include a stereoscopic option. At present we are not aware of any stereoscopic video games for the console systems.

Therefore, there is a need in the art for a method and apparatus that causes a 2D video game console system to generate images that can be viewed on a television system in stereoscopic 3D.

### SUMMARY OF THE INVENTION

The present invention relates to a method and apparatus for creating stereoscopic 3-D images on a video monitor while playing a videogame.

In one aspect, the invention may comprise a method of producing a stereoscopic three-dimensional image while playing a video game having a player look-at position being displayed on a monitor having a vertical refresh signal, comprising the step of producing a stereoscopic image pair by shifting the player look-at position to the left and to the right of the actual player look-at position, and transmitting the image pair to the monitor such that the left image alternates with the right image synchronized to the vertical refresh signal.

In another aspect, the invention may comprise an apparatus for use with a video game system including a controller, a console, and a monitor, said apparatus comprising:
(a) means for receiving a player look-at position signal from the controller;
(b) means for shifting the player look-at position to the left and to the right to create a left image and a right image;
(c) means for detecting a vertical refresh signal being supplied to the monitor;
(d) means for transmitting the left image and the right image to the monitor such that the left image and the right image separately display on alternating vertical refresh cycles.

In another aspect, the invention may comprise an apparatus for use with a video game system including a controller, a console, and a monitor, said apparatus comprising:
(a) a first circuit for receiving signals, including a player look-at position signal, outputted from the controller;
(b) a second circuit for shifting the player look-at position to the left and to the right to create a left image and a right image;
(c) a vertical refresh signal sensor;
(d) a third circuit, operatively connected to vertical refresh signal sensor, for alternating the left image and the right image separately on alternating vertical refresh cycles, wherein the vertical refresh signal coincides with the vertical refresh cycle.

### BRIEF DESCRIPTION OF DRAWINGS

These and other objects and features of the present invention will become apparent from the following description, viewed in conjunction with the attached drawings. Through these drawings, like parts are designated by like reference numbers:

FIG. 1 is an illustration of the top plan view of the invention including the electronics circuit (40), game console system (20), joystick (30), television (10) and liquid crystal glasses (50) described in accordance with the invention herein.

FIG. 2 is a schematic view of the player look-at point and its left-right shifts used to produce stereoscopic image pairs.

### DETAILED DESCRIPTION OF THE PREFERRED EMBODIMENT

The present invention is intended to provide a method and apparatus that causes a 2D video game console system to generate stereoscopic 3D images and viewed in 3D on a 2D television or computer monitor without utilizing 2D conversion techniques and does not require pre-rendered stereoscopic video games or content.

The present invention is particularly suited to video games that allow the adjustment of the game player's look-at position, where the player's on-screen view of the game world simulates that of a game character. Many video games such as well-known first person shooter style games offer a player look-at position. When using a game title that allows adjustment of the player's camera or look-at position, and when the bi-directional data stream may be altered to include stereoscopic movements synchronized and used in conjunction with a typical television and conventional LCD shutter glasses, the player is presented with a pair of correctly generated stereoscopic images that cause the viewer to see 3D video games generated on a 2D game console system and presented on a 2D video monitor.

Those skilled in the art will realize that the method and apparatus described herein apply equally to video games adapted for play on a personal computer (PC) or on a proprietary console system, such as xBox™, Nintendo™ and Sony Playstation™.

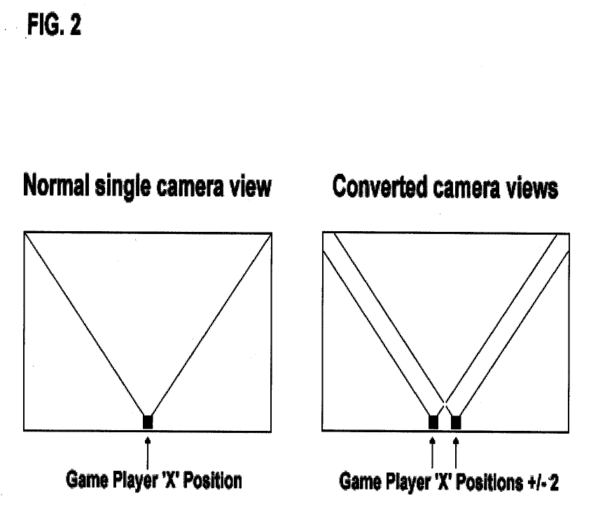

The invention employs electronic circuitry to intercept and alter the bi-directional signals between a video game console system and joystick. In a first person shooter style game, the joystick (or other control mechanism) is used to move the character, and the look-at position changes accordingly. The technique described herein alters the console host and control joystick bi-directional data stream that are used to control the game players look-at point. The alteration of the data stream includes the insertion of lateral movement commands that corresponds to the generation of correct stereoscopic image pairs. As shown in FIG. 2, if the game look-at position is shifted to the right and to the left, a pair of images from slightly different positions may be generated. This image pair may serve as a stereoscopic image pair.

Many modern video games employ a camera technique that allows the game player to move their game character inside the virtual world with the use of a joystick. Typical programming methods that are used to create a game world are to recalculate and reconstruct the game scene each time a player moves. Electronic circuitry (40) inputs a fake movement into the data stream. Typical data streams are sequences of data that correspond to a joystick button press. For example, on the Sony Playstation II™, the buttons labeled as Right Analog Joystick cause the look-at position of the player to be adjusted. By inserting an alternating bit into the corresponding Right Analog Joystick bit, the game console renders an appropriate image. By adding a +1 into the data stream, which is sent to the game console system (20), during alternating vertical retrace cycles, causes the game console system (20) to generate a left view every other display retrace refresh. The electronic circuitry (40) then inputs a −1 into the data stream, which is sent to the game console system 20, which causes the game console system 20 to generate a right view, alternating with the left view. The game console thereby generates correct stereoscopic left and right views which are synchronized between the left and right eyes by liquid crystal glasses and cause the video game player to see stereoscopic images on a game console system.

Similar commands or insertions may easily be determined by those skilled in the art for other brands or hardware devices which facilitate player look-at viewpoint during game play.

Thus, in one embodiment, the device may employ an electronic method of decoding signals from a joystick and recoding the data stream sent to the video game console system. The device adjusts the video game sprite look-at lateral position every other frame after which the joystick data is then sent to the game console system for processing. The insertion of correct left and right shifts into the data stream is synchronized with the refresh cycle of the television or computer monitor. By synchronizing left-right alternations of liquid crystal shutter glasses with the constant regenerated scene causes the viewer to observe a correct stereoscopic pair. The combination of alternating left-right adjustments to the data stream when used with liquid crystal glasses on a television system cause the viewer to see the video game in 3D.

In its simplest form, the invention requires a source of power to supply the electrical needs to the various components described hereafter. A preferred electrical source is the power lead on the game consoles joystick port however a variety of devices may be used and are readily available to supply power for the requirements of the invention. One skilled in the art will realize that alternate power supplies may employ batteries, fuel cells, power adapters, electrical generators or any other form of adequate power supply means.

It is preferred to use an electronic programmable chip to decode, modify and encode the bi-directional electronic signals sent between the joystick to the game console, however a variety of synchronous chip arrays may be employed to accomplish the same results. One skilled in the art will realize that alternate electronic configurations other than electronic programmable chips can be employed to decode, modify and encode the bi-directional electronic signals. In one embodiment, a pre-programmed chip that includes compatible protocols already used by the game console, such as a Sony Playstation™, may be utilized.

One embodiment of the present invention employs a programmed electronic chip that contains the functions to decode, modify and encode the joystick signals by specifically altering every other output image sent to the game console in a manner as so as to adjust the game players ‘X’ position within the game coordinate grid. One skilled in the art will realize that a programmed electronic chip array and electronic circuit can be placed in between the joystick and the video game console system, however the circuitry and algorithms can be incorporated as part of the joystick electronics or within the game console. Embodiments of the present invention are not limited to those being placed between the joystick and game console system. Alternative embodiments may be integrated within the joystick apparatus or within the game console.

It is preferred to use an existing pair of liquid crystal 3D glasses that are synchronized to the television's vertical retrace pulse. Typical liquid crystal glasses employ lens that turn opaque when power is applied to them and turn clear when the power is removed. By alternating the power supply between the left and right LCD lens and synchronized with the television vertical retrace signal, the glasses alternate between clear and dark states synchronized with the television vertical retrace rate.

Television vertical refresh pulses can be detected from a variety of means. One such method is to connect an RCA cable to a televisions RCA output and detect the vertical retrace signal with the use of electronic circuitry, as exemplified in U.S. Pat. No. 6,295,065, the contents of which are incorporated herein by reference. This detected electronic pulse is used to trigger left and right liquid crystal glasses lens. Alternatively, the data stream sent from the joystick to the video game console system is decoded to detect the vertical pulse signal sent to the television.

A separate left image for the left eye and a separate right image for the right eye are generated by shifting the player look-at position as described above. Liquid crystal glasses alternating between clear and dark synchronized with the vertical refresh rate of a television while generating synchronized left and right images, thereby allow each of the viewers eyes to independently view a separate image.

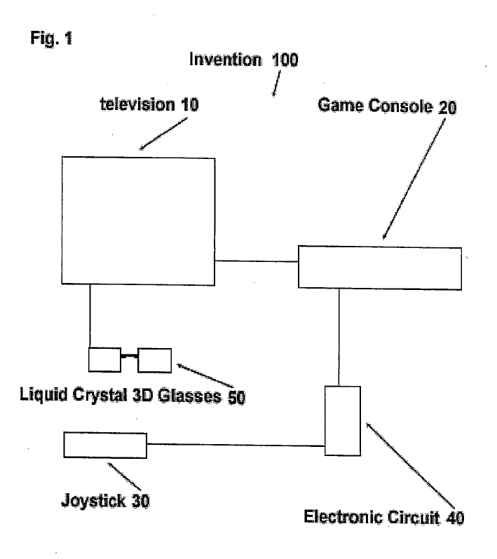

A preferred embodiment of the invention (100), which when used in conjunction with liquid crystal glasses presents the viewer with a stereoscopic pair of images generated from a 2D video game console system without utilizing 2D conversion techniques or require pre-rendered stereoscopic content, is shown in FIG. 1.

In one embodiment, the invention (100) employs a video game console system (20) that are readily commercially available with current brand names such as Sony's PlayStation I™, Sony's PlayStation II™, Microsoft's XBox™ and Nintendo's Game Cube™. It should be apparent that the invention (100) herein described may be adapted to either older, current or future game console systems (20) as well as computer joystick (or keyboard or mouse controlled) systems, without departing from the scope of the described invention (100).

The invention (100) relies on a joystick (30) or similar controller that is either a part of the video game console (20) or can supplied by a third party. The joystick (30) is used by the player to “move” within the game by shifting the player's look-at position. As may be appreciated by those skilled in the art, such movement control may be accomplished by a variety of input devices, including joysticks, keyboards, and computer mice. It should be apparent that the invention (100) herein described may be adapted to either older, current or future joysticks (30) without detracting from spirit of the scope of the described invention (100).

The apparatus (100) produces images which may be displayed on a conventional NSTC or PAL television (10) or video monitor. Television (10) can include a CRT or other display that employs an interlaced vertical scan, non-interlaced vertical scan or progressive scan refresh mechanism. Typical televisions (10) in use today operate on either an NTSC or PAL standard that refreshes the display at 60 or 50 times per second respectively. The display may also comprise non-interlaced displays having vertical scan refresh mechanisms, such as CRT computer monitors.

The invention (100) is used in conjunction with liquid crystal glasses (50) that are commercially available from several manufacturers and distribution channels. Liquid crystal glasses (50) may be connected to the television (10) via the RCA video out port. Liquid crystal glasses electronic circuit (50) detects the television's (10) vertical retrace pulse which cause each liquid crystal glasses (50) lens to alternate between a clear and dark state. Liquid crystal glasses (50) therefore alternate lens between a clear and dark state at the same rate as the television (10) vertical retrace pulse of 60 (NTSC) or 50 (PAL) times per second. It should be apparent that the invention 100 herein described can be used with older, current or future liquid crystal glasses (50) without departing from the scope of the claimed invention. It should also be apparent that the vertical retrace pulse can be detected within the bi-directional data stream and therefore the glasses controlling electronic circuitry may be connected in between the joystick and console system, or designed within the joystick or inside the game console system.

The apparatus (100) utilizes an electronic circuit (40) that intercepts the coded signals sent from the joystick (30) to the video game console (20). Preferably, the electronic circuit (40) receives power needs from game console system (20). Electronic circuit (40) uses a programmable semi-conductor chip that contains instructions to decode the joystick (30) signal sent to the game console (20) and inserts a compatible code into the joystick (30) signal that adjusts the video game players lateral or ‘x’ position +1 unit on the first frame and −1 on the next frame. The resulting ‘x’ or lateral adjustment shifts the player look-at view slightly to each side. The lateral shifts are synchronized with the television (10) vertical retrace refresh rate and thus a stereoscopic left and right image pair is created. The left and right images are alternated, and synchronized with the television's (10) refresh rate. Used in conjunction with stereoscopic liquid crystal glasses (50), the viewer is presented with a stereoscopic left image for the viewers left eye and the right image for the right eye.

The resulting left and right shift caused by the semi-conductor chip set inserting the left and right shift to the video game players ‘x’ position is shown schematically in FIG. 2. The displayed image rapidly shifts between two player view points which are to the left and right of the game players actual look-at position.

As may be appreciated by those skilled in the art, the device or circuit 40 may be incorporated into a separate housing between the joystick or game controller (30) and the game console (20), or it may be integrated into either the joystick or game controller (30) or the game console (20).

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

What is claimed is:

1. A method of producing a stereoscopic three-dimensional image while playing a video game having a player look-at position being displayed on a monitor having a vertical refresh signal, comprising the step of producing a stereoscopic image pair by shifting the player look-at position to the left and to the right of the actual player look-at position, and transmitting the image pair to the monitor such that the left image alternates with the right image synchronized to the vertical refresh signal.

2. An apparatus for use with a video game system including a controller, a console, and a monitor, said apparatus comprising:
(a) means for receiving a player look-at position signal from the controller;
(b) means for shifting the player look-at position to the left and to the right to create a left image and a right image;
(c) means for detecting a vertical refresh signal being supplied to the monitor;
(d) means for transmitting the left image and the right image to the monitor such that the left image and the right image separately display on alternating vertical refresh cycles.

3. An apparatus for use with a video game system including a controller, a console, and a monitor, said apparatus comprising:
(a) a first circuit for receiving signals, including a player look-at position signal, outputted from the controller;
(b) a second circuit for shifting the player look-at position to the left and to the right to create a left image and a right image;
(c) a vertical refresh signal sensor;
(d) a third circuit, operatively connected to vertical refresh signal sensor, for alternating between the left image and the right image in synchronicity with the vertical refresh signal sensor.
